(19) United States
(12) Patent Application Publication
(10) Pub. No.: US 2026/0266195 A1
(43) Pub. Date: Sep. 10, 2026

(54) MAGNETIC LEVITATION-BASED HYBRID PROPULSION SYSTEM

(71) Applicant: Maglev Aero Inc., Hopkinton, MA (US)

(72) Inventors: Ian Morris Randall, Hopkinton, MA (US); Roderick K. Randall, Hopkinton, MA (US)

(73) Assignee: Maglev Aero Inc., Hopkinton, MA (US)

(21) Appl. No.: 19/560,838

(22) Filed: Mar. 9, 2026

Related U.S. Application Data
(60) Provisional application No. 63/769,404, filed on Mar. 10, 2025.

(51) Int. Cl. F01D 15/10; F04D 13/06; H02K 7/18

(52) U.S. Cl. CPC F01D 15/10; H02K 7/1823; F04D 13/0646; F05D 2220/323; F05D 2220/768

(57) ABSTRACT

Systems and methods relate to magnetic levitation-based hybrid propulsion. The system can include an engine coupled to a shaft, the engine including a compressor and a combustor. The system can include a fan including a plurality of rotor blades coupled to the shaft. The system can include a drive system including a rotor coupled with the plurality of rotor blades and a stator to provide power to the rotor.

### CROSS REFERENCE TO RELATED APPLICATION

The present application claims the benefit of and priority to U.S. Provisional Patent Application No. 63/769,404, filed Mar. 10, 2025, which is incorporated herein by reference in its entirety and for all purposes.

### TECHNICAL FIELD

The present disclosure relates generally to propulsion systems. More particularly, the present disclosure relates to magnetic levitation-based hybrid propulsion systems.

### BACKGROUND

Various propulsion platforms can utilize hybrid propulsion systems, combining gas turbine engines with electric motors. Propulsion systems can provide lift and cruise for propulsion platforms.

Propulsion systems that combine electric and turbine components, such as hybrid propulsion systems, can have issues with vibration and shaft deformation. In addition, such systems may have challenges integrating electric motors and traditional turbine components, leading to added complexity and reduced efficiency. As such, these systems can have negative technical limitations that make such the use of both electric and turbine components difficult to achieve.

### SUMMARY

Some arrangements relate to a system for magnetic levitation-based hybrid propulsion, including: an engine coupled to a shaft, the engine including a compressor and a combustor; a fan including a plurality of rotor blades coupled to the shaft; a drive system including a rotor coupled with the plurality of rotor blades and a stator to provide power to the rotor.

Some arrangements relate to a system, wherein the rotor is at least partially spaced from the stator by a gap.

Some arrangements relate to a system, wherein the drive system includes a plurality of rotor magnets and a plurality of stator magnets, the plurality of stator magnets configured to output one or more magnetic fields to interact with one or more of the plurality of rotor magnets to drive the rotor.

Some arrangements relate to a system, wherein at least one of the plurality of rotor magnets are positioned at a tip of a corresponding rotor blade, and the plurality of stator magnets are configured to output the one or more magnetic fields to drive the at least one of the plurality of rotor magnets at the tips of the corresponding rotor blade to rotate the fan.

Some arrangements relate to a system, wherein the plurality of stator magnets is arranged in at least one of: an axial flux configuration in which the plurality of stator magnets is positioned on opposite axial sides of the plurality of rotor magnets; or a radial flux configuration in which the plurality of stator magnets is positioned radially outward from tips of the plurality of rotor blades.

Some arrangements relate to a system, wherein the drive system is configured to drive the rotor blades to provide airflow to the engine via the fan, and wherein the engine further provides power to the fan and thrust, and wherein the stator and associated control circuitry are integrated into a rim of the fan.

Some arrangements relate to a system, wherein the shaft extends from the engine to the fan to couple the engine with the fan, and wherein the plurality of rotor blades is coupled to a central hub of the fan such that a load path traverses from tips of the plurality of rotor blades through the central hub into a central core of the shaft.

Some arrangements relate to a system, wherein the fan includes a shrouded fan having the plurality of rotor blades enclosed by a casing, wherein the plurality of rotor blades include a plurality of rotor magnets, and wherein the stator and the plurality of rotor magnets are arranged at the casing to form a tip-driven motor integrated with a rim of the shrouded fan.

Some arrangements relate to a system, further including a controller configured to: receive a command indicating a maneuver of a propulsion platform; determine an operation mode based on the command; and generate one or more drive signals based on the operation mode to operate at least one of the drive system and the engine.

Some arrangements relate to a system, wherein the operation mode includes at least one of a takeoff mode, a climb mode, a cruise mode, and a landing mode, and wherein the controller is configured to: in the takeoff mode or the landing mode, operate the engine and the drive system in parallel to drive the fan; and in the cruise mode, operate the engine to drive the fan while reducing power delivered by the drive system.

Some arrangements relate to a method for operating a magnetic levitation-based hybrid propulsion system, the method including: receiving, by the controller, a command indicating a maneuver of a platform; determining, by the controller, at least one operation mode based on the command; generating, by the controller, one or more signals based on the at least one operation mode; and operating at least one of a magnetic levitation-based drive system and a turbine-based engine based on the one or more signals, wherein operating the magnetic levitation-based drive system includes driving, based on the one or more signals, a plurality of stator magnets of a stator to output one or more magnetic fields that interact with one or more rotor magnets of a rotor to drive a plurality of rotor blades acting as a fan.

Some arrangements relate to a method, further including: in response to determining that the at least one operation mode corresponds to at least one of a takeoff mode and a landing mode, generating the one or more signals to operate the turbine-based engine and the magnetic levitation-based drive system in parallel to drive the plurality of rotor blades.

Some arrangements relate to a method, further including: in response to determining that the at least one operation mode corresponds to a cruise mode, generating the one or more signals to operate the turbine-based engine to drive the plurality of rotor blades while reducing power delivered by the magnetic levitation-based drive system.

Some arrangements relate to a method, further including: determining, by the controller, an upcoming transition between a first operation mode and a second operation mode; and adjusting the one or more signals prior to the transition to change a relative contribution of the turbine-based engine and the magnetic levitation-based drive system to driving the plurality of rotor blades.

Some arrangements relate to a method, wherein driving the plurality of stator magnets includes applying time-varying electrical currents to coils of the stator to generate the one or more magnetic fields, and wherein the one or more magnetic fields cause the rotor to rotate while being at least partially spaced from the stator by a gap.

Some arrangements relate to a method, further including: generating, by rotation of the plurality of rotor blades, airflow toward a compressor of the turbine-based engine; and generating, by the turbine-based engine, thrust based on combustion of fuel with compressed air from the compressor.

Some arrangements relate to a method, further including: transmitting torque from tips of the plurality of rotor blades through a central hub of a fan and into a shaft coupled to the turbine-based engine, the torque being generated at least in part by interaction between the plurality of stator magnets and the one or more rotor magnets.

Some arrangements relate to a method, further including: causing, based on operating of the magnetic levitation-based drive system and the turbine-based engine, a change in at least one of lift, thrust, pitch, roll, or yaw of a vehicle including the hybrid propulsion system.

Some arrangements relate to a vehicle, including: a fuselage; and a propulsion system coupled to the fuselage, the propulsion system including: an engine coupled to a shaft, the engine including a compressor and a combustor; a fan including a plurality of rotor blades coupled to the shaft; and a drive system including a rotor coupled with the plurality of rotor blades and a stator configured to provide power to the rotor.

Some arrangements relate to a vehicle, wherein the drive system includes a plurality of rotor magnets and a plurality of stator magnets, at least one rotor magnet positioned at a tip of a corresponding rotor blade, and the plurality of stator magnets configured to output one or more magnetic fields that interact with the at least one rotor magnet at the tip of the corresponding rotor blade to drive the fan.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram of various systems of a hybrid propulsion system.

FIG. 2 is a schematic diagram of an implementation of the hybrid propulsion system of FIG. 1.

FIG. 3 is a flow diagram illustrating a method for controlling operation of a hybrid propulsion system.

### DETAILED DESCRIPTION

Hybrid propulsion systems can combine gas turbine engines with electric motors to generate thrust for various aerial platforms. Such systems can include a turbine-based engine that operates in parallel with an electric motor, where both components can contribute to driving a fan to produce airflow and propulsion. In various configurations, a shaft can mechanically couple the turbine engine to the fan, such that rotational energy from the turbine is transmitted to the fan blades. The electric motor can be positioned along the shaft or can be integrated at other locations within the propulsion assembly. Hybrid propulsion architectures can provide flexibility in power allocation during different phases of flight, such as takeoff, climb, cruise, and landing.

Conventional hybrid propulsion systems can rely on an extended shaft with an electric motor positioned between the turbine-based engine and the fan. The extended shaft length can introduce increased modes of vibration and shaft deformation, which can require complex bearing assemblies or damper components to manage dynamic loads. Additionally, some systems can employ multiple concentric rotating shafts to distribute power, which can add mechanical complexity and weight to the overall propulsion assembly. The placement of the electric motor in-line with the shaft can result in packaging challenges and can limit the structural efficiency of the load path from the fan blades to the central shaft core. In certain configurations, fan blades can be cantilevered from a central hub, which can impose higher stress concentrations and can require additional structural reinforcement to prevent buckling or deformation under load.

The techniques described herein can provide a magnetic levitation-based hybrid propulsion system in which a drive system can be integrated into a rim of a fan, rather than being positioned in-line along a central shaft. The drive system can include a stator with a plurality of stator magnets and a rotor with a plurality of rotor magnets, where the stator magnets can output electromagnetic fields to interact with the rotor magnets to drive rotor blades of the fan. In various implementations, the rotor magnets can be positioned at or near the tips of the rotor blades, such that the fan is driven by electromagnetic interaction at the rim rather than by mechanical coupling along a central shaft. The techniques can allow for a reduced shaft length, because the electric motor components can be located at the fan rim and do not require the shaft to extend to accommodate an in-line motor.

To implement the techniques described herein, a system can include a turbine-based engine coupled to a shaft, where the engine can include a compressor and a combustor. A fan can include a plurality of rotor blades coupled to the shaft at a central hub, such that rotational force from the turbine engine and/or from the drive system can be transmitted through the central hub to the shaft. The drive system can include a stator and a rotor, where the stator can include stator magnets that can be integrated into or positioned at a rim of the fan. The rotor can include rotor magnets that can be coupled with the rotor blades, such that the rotor magnets are positioned at or near the tips of the rotor blades. Control circuitry (e.g., a controller) can generate signals to drive the stator magnets to output electromagnetic fields, where the electromagnetic fields can interact with the rotor magnets to produce torque at the blade tips. The rotor can be at least partially spaced from the stator by a gap, such that the rotor and/or stator do not mechanically contact during rotation. The gap distance can vary during operation as the rotor moves relative to the stator, and the electromagnetic interaction can be maintained across the gap to provide propulsion. In some implementations, the stator magnets can be arranged in an axial flux configuration, where the stator magnets are positioned on opposite axial sides of the rotor magnets. In other implementations, the stator magnets can be arranged in a radial flux configuration, where the stator magnets are positioned radially outward from the tips of the rotor blades. The fan can be a shrouded fan, where the rotor blades are enclosed by a casing or duct. The stator and associated control circuitry can be integrated into the rim or the casing of the shrouded fan.

The techniques described herein can provide a load path that traverses from the tips of the rotor blades through the central hub into a central core of the shaft, such that the rotor blades are not cantilevered and/or structural stress can be distributed more effectively. The reduced shaft length can decrease the number of vibration modes that can be excited during operation, which can reduce the complexity of bearing and/or damper components required to maintain shaft stability. By integrating the electric motor components at the rim of the fan, the techniques can eliminate the need for an in-line motor along the shaft, which can reduce overall system weight and/or mechanical complexity. The magnetic levitation-based drive system can operate in parallel with the turbine engine, such that both power sources can contribute to driving the fan during high-demand phases such as takeoff and/or landing, while the turbine engine alone can provide propulsion during cruise when power demand is lower. The techniques can improve power density and/or efficiency per unit disk area relative to hub-driven electric motor configurations, because the electromagnetic interaction at the blade tips can produce torque at a larger effective radius. The system can allow for flexible power allocation across different flight phases, which can improve energy efficiency and/or can reduce battery requirements for electric propulsion during critical operations.

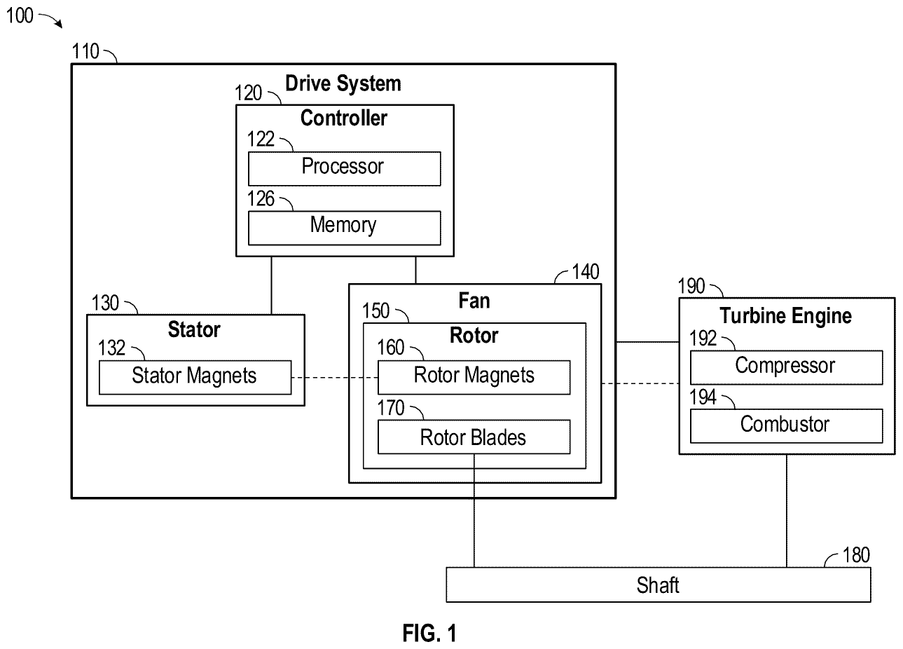

Referring now to FIG. 1, illustrated is a block diagram of a system 100 for magnetic levitation-based hybrid propulsion. The system 100 can include a drive system 110, a shaft 180, and/or a turbine engine 190. The drive system 110 can include a controller 120, a stator 130, a fan 140, and/or a rotor 150. The controller 120 can include a processor 122 and/or memory 126. The stator 130 can include stator magnets 132. The fan 140 and/or rotor 150 can include rotor magnets 160 and/or rotor blades 170. The turbine engine 190 can include a compressor 192 and/or a combustor 194.

The system 100 can be a hybrid propulsion system for generating propulsion for a vehicle. For example, the system 100 can use the drive system 110 and turbine engine 190 in separately and/or in parallel to produce thrust for a propulsion platform. The drive system 110 can be positioned within a motor bearing to drive electromagnets positioned within the motor bearing. The drive system 110 can be used to augment the turbine engine 190 to produce additional power and/or airflow into the turbine engine 190. In some implementations, the drive system 110 can include, or act as a magnetic levitation-based motor.

The drive system 110 can include the controller 120 (e.g., control circuitry), which can include a processor 122 and memory 126. The processor 122 may be implemented, for example, as a specific purpose processor, an application specific integrated circuit (ASIC), one or more field programmable gate arrays (FPGAs), a group of processing components, and/or any other suitable electronic processing components or processors. The processor 122 may be a distributed computing system or a multi-core processor. The memory 126 can be one or more devices (e.g., RAM, ROM, flash memory, hard disk storage, etc.) for storing data and computer code for completing and/or facilitating the various processes, layers, and/or operations described in the present disclosure. The memory 126 may be or include volatile memory or non-volatile memory and may include database components, object code components, script components, or any other type of information structure for facilitating the various activities and/or information structures disclosed herein. The memory 126 can be communicably connected to the processor 122 and can include computer code or instruction sets for executing one or more processes described herein. The memory 126 can include various circuits, software engines, and/or instruction sets that cause the processor 122 to execute the systems and methods described herein. The memory 126 may be distributed across disparate devices.

The controller 120 can use flight dynamics models, rotor state, and/or control laws to convert desired movement of a propulsion platform into control signals and transmit the control signals to the stator 130 to cause the propulsion platform to achieve the desired movement. The controller 120 can receive and transmit signals to and from receiver electronics, transmitter electronics, sensors, radios, datalinks, and/or other remote platforms and/or components coupled with other components of the system 100. The controller 120 can receive a command indicating a maneuver or desired movement of the platform. In some implementations, the controller 120 can determine one or more operation modes based on the command. For example, the controller 120 can use a flight dynamics model to calculate a lift expected to be generated by the rotor 150 of the platform and/or to calculate a lift or propulsion expected to be generated by the turbine engine 190 of the platform. The controller 120 can determine an amount of power or percentage of power generated by the magnetic levitation-based drive system 110 and/or the turbine engine 190. In some implementations, the controller 120 can generate signals based on the operation mode to control at least one of the drive system 110 or the turbine engine 190. For example, the controller 120 can generate signals to operate both the drive system 110 and the turbine engine 190 to generate lift at takeoff or control lift at landing. The controller 120 can generate signals to operate only the turbine engine 190 during a cruise operation mode. The controller 120 can operate the drive system 110 by providing signals to the stator 130 to drive stator magnets 132 to output a corresponding electromagnetic field. Each stator magnet 132 can vary a magnitude of the outputted electromagnetic field as a function of time depending on the received signal. For example, if the control signal has varying values of parameters such as amplitude and/or frequency, the amplitude and/or frequency of the electromagnetic field can vary correspondingly.

In some implementations, the controller 120 can be implemented as a magnetic levitation inverter controller for controlling magnet interactions between the stator 130 and the rotor 150. The controller 120 can generate time-varying drive signals to the stator magnets 132 to produce electromagnetic fields that interact with the rotor magnets 160 to drive rotation of the rotor 150. The controller 120 can interface with heat exchange inverters (e.g., heat exchange diverter 210, heat exchanger pipe, etc.) to facilitate thermal management of the drive system 110 during operation. For example, the controller 120 can transmit control signals to the heat exchange inverters to adjust heat dissipation rates based on detected operating temperatures of the stator 130 or the rotor 150. The controller 120 can receive temperature sensor data from the heat exchange inverters and can adjust drive signals to the stator magnets 132 to maintain electromagnetic field outputs within thermal operating limits.

The drive system 110 can include the stator 130. The stator 130 can include a plurality of stator magnets 132 arranged to output electromagnetic fields that interact with the rotor magnets 160 of the rotor 150. In some implementations, electromagnets of the stator 130 (e.g., stator magnets 132) and electromagnets of the rotor 150 (e.g., rotor magnets 160) can be electric magnets made from various conductive materials, such as aluminum, copper, and/or other conductive materials, among others. In some implementations, aluminum can be used based on being light weight, having high thermal conductivity, and/or having high electrical conductivity. In some implementations, copper can be used based on the ability for copper to allow the flux from the rotor 150 to traverse through the copper. In some implementations, copper can be used based on the ability of copper to be integrated with embedded cooling systems to absorb heat. In some implementations, the stator 130 can be implemented as a stationary electromagnetic assembly positioned at or near the rim of the fan 140. For example, the stator 130 can be integrated into a casing or shroud that encloses the rotor blades 170 such that the stator magnets 132 are positioned adjacent to the tips of the rotor blades 170 where the rotor magnets 160 are located. The stator 130 can receive control signals from the controller 120 to energize the stator magnets 132 in a time-varying manner.

In some implementations, the control signals can specify current waveforms to be applied to coils of the stator magnets 132 such that the resulting electromagnetic fields produce torque on the rotor magnets 160. In some implementations, the one or more rotor magnets 160 can be inductively coupled with the stator magnets 132 to allow the rotor 150 to receive an electromotive force from the stator 130. For example, the rotor 150 can receive an electromotive force over a gap between the rotor magnets 160 and the stator magnets 132, where the gap can be an air gap. The stator 130 can be at least partially spaced from the rotor 150 by a gap. The gap can be a non-contact spacing that prevents the rotor magnets 160 from physically contacting the stator magnets 132 as the rotor 150 rotates relative to the stator 130. For example, the gap can prevent the rotor magnets 160 from contacting coils of the stator magnets 132 as the rotor blades 170 rotate about a central axis of the shaft 180. The gap can have a gap distance measured between a surface of a rotor magnet 160 and a surface of a stator magnet 132. In some implementations, the gap distance can be defined as a distance between a magnet surface and a coil surface, where the coil surface can be a surface of a coil of the stator magnets 132 that is nearest to the rotor magnets 160. The size of the gap distance can affect the magnetic coupling efficiency between the stator magnets 132 and the rotor magnets 160. For example, a smaller gap distance can increase the magnetic flux density experienced by the rotor magnets 160, which can increase the torque transmitted to the rotor blades 170 for a given level of stator excitation. The gap distance can be a variable distance that changes during operation of the drive system 110. For example, the rotor 150 can begin operation in a neutral position in which the rotor 150 is centered with respect to the stator 130 such that the gap distance is uniform on all sides of the rotor 150. During operation, the rotor 150 can move relative to the stator 130 due to dynamic loads, aerodynamic forces, or variations in electromagnetic forces such that the gap on a first side of the rotor 150 becomes smaller than the gap on a second side of the rotor 150. In such conditions, a gap distance on the first side can be less than a gap distance on the second side.

The stator magnets 132 can interact with the rotor magnets 160 of the rotor 150 to produce torque and/or to maintain spacing between the stator 130 and the rotor 150. For example, as the stator magnets 132 output electromagnetic fields, the electromagnetic fields can exert forces on the rotor magnets 160 that cause the rotor 150 to rotate. The rotation of the rotor 150 can generate lift or thrust as the rotor blades 170 move air. In some embodiments, the resulting aerodynamic forces can cause the rotor 150 to apply force to the stator 130 via the magnetic interaction between the stator magnets 132 and the rotor magnets 160. In some implementations, the stator magnets 132 can be positioned in an axial flux configuration. For example, a first plane can be defined as passing through the central axis of the shaft 180 and/or being perpendicular to the rotor blades 170. In the axial flux configuration, the stator magnets 132 can be positioned such that they are aligned along an axis that is parallel to the first plane. For example, the stator magnets 132 can be placed on opposite axial sides of the rotor magnets 160, such as above and below the rotor blades 170, creating an axial flux configuration in which the magnetic fields interact along the axis of rotation of the rotor 150. In some implementations, the stator magnets 132 can be positioned in a radial flux configuration. For example, a second plane can be defined as perpendicular to the central axis of the shaft 180 and intersecting a rotor blade 170. In the radial flux configuration, the stator magnets 132 can be positioned radially outward from the tips of the rotor blades 170 such that the stator magnets 132 are positioned around the circumference of the rotor 150, creating a radial flux configuration in which the magnetic fields between the stator magnets 132 and rotor magnets 160 interact radially, perpendicular to the axis of rotation. In some implementations, the axial flux configuration can be used for relatively smaller propulsion systems in which the rotor 150 has a smaller diameter and/or the axial spacing between stator magnets 132 positioned on opposite axial sides of the rotor magnets 160 can be maintained within acceptable manufacturing tolerances. In some implementations, the radial flux configuration can be used for relatively larger propulsion systems in which the rotor 150 has a larger diameter and/or the radial positioning of the stator magnets 132 around the circumference of the rotor 150 can provide a more uniform magnetic flux distribution at the rotor magnets 160.

The drive system 110 can include the rotor 150, which can include one or more rotor magnets 160 and one or more rotor blades 170. The rotor blades 170 can be coupled to the shaft 180 at a central hub of the fan 140. In some implementations, the rotor magnets 160 can be positioned at or near the tips of the rotor blades 170. For example, the rotor magnets 160 may be embedded within the blade tips, mounted to outer surfaces of the blade tips, or integrated into tip structures that extend from the distal ends of the rotor blades 170. The stator 130 can provide power to the rotor 150 by outputting electromagnetic fields via the stator magnets 132 that interact with the rotor magnets 160 at the blade tips to generate torque. The electromagnetic fields can exert forces on the rotor magnets 160 that cause the rotor blades 170 to rotate about the central axis of the shaft 180. In some implementations, the central hub can transmit rotational force from the blade tips to a central core of the shaft 180.

For example, the central hub may include bearings or coupling structures that transfer torque from the rotor blades 170 into the shaft 180, such that the rotational motion generated by the electromagnetic interaction at the blade tips propagates through the central hub and into the shaft 180. The central hub can receive rotational force from both the drive system 110 via the rotor blades 170 and from the turbine engine 190 via the shaft 180, and/or can sum or combine these torque contributions to drive the fan 140. In some implementations, the central hub can include one or more electric motors to control the position of the rotor blades 170. For example, the electric motors may adjust blade pitch angles or azimuthal positions of the rotor blades 170 to modify thrust or aerodynamic loading during operation. In some implementations, a battery powered motor can be coupled to the central shaft to drive the magnetic levitation-based component of the hybrid system. For example, the battery powered motor may supply electrical current to the stator magnets 132 via the controller 120 to maintain or augment the electromagnetic fields during phases of operation in which the turbine engine 190 provides reduced power. The drive system 110 and the turbine engine 190 can operate in parallel to control lift, thrust, pitch, roll, and/or yaw of a vehicle by adjusting the relative power contributions from each source. For example, the controller 120 may generate signals to increase power delivered by the drive system 110 while reducing power delivered by the turbine engine 190 to produce a change in pitch angle of the vehicle, or may generate signals to increase power delivered by both the drive system 110 and the turbine engine 190 to increase total thrust and/or produce a change in altitude of the vehicle.

The fan 140 can include the plurality of rotor blades 170 coupled to the shaft 180. The rotor blades 170 can rotate about the central axis of the shaft 180 to generate thrust by moving air in an axial direction through the fan 140. In some implementations, the stator magnets 132 can output electromagnetic fields that interact with the rotor magnets 160 positioned at the tips of the rotor blades 170 to drive rotation of the fan 140. For example, the stator magnets 132 may be energized in a time-varying sequence that produces a rotating magnetic field pattern, and the rotor magnets 160 at the blade tips may follow the rotating field pattern such that the rotor blades 170 are driven to rotate continuously. The fan 140 can generate thrust for the system 100 by accelerating air through the rotor blades 170 and expelling the air downstream toward the compressor 192 or toward an exhaust outlet. The drive system 110 can provide additional power to the system 100 by driving the fan 140 through the electromagnetic interaction between the stator 130 and the rotor 150, such that the fan 140 receives torque contributions from both the turbine engine 190 and the drive system 110 operating in parallel.

The fan 140 can be a shrouded fan in which the rotor blades 170 are enclosed by a casing or a duct. The casing or duct can reduce the loss of airflow at the tips of the rotor blades 170 by preventing air from leaking around the blade tips rather than passing through the intended flow path. In some implementations, components of the drive system 110 can be positioned at a rim of the fan 140. For example, the stator 130, the stator magnets 132, and the controller 120 may be integrated into or mounted to the outer rim of the fan 140, such that the electromagnetic components of the drive system 110 are distributed around the circumference of the fan 140 rather than being located along a central shaft. The outer rim of the fan 140 can include the stator 130, the stator magnets 132, the controller 120, or any combination thereof. In some implementations, the rim of the fan 140 can include a motor bearing 215 that supports the rotor 150 and/or maintains the gap between the rotor magnets 160 and the stator magnets 132 during rotation. For example, the motor bearing 215 may be a magnetic bearing or a mechanical bearing that constrains radial and/oraxial motion of the rotor 150 relative to the stator 130 while allowing the rotor 150 to rotate freely about the central axis of the shaft 180.

The system 100 can include or be coupled with the shaft 180. In some implementations, the shaft 180 can be coupled with the turbine engine 190 and the fan 140. In some implementations, the shaft 180 can extend from a portion of the turbine engine 190 to the fan 140. For example, the shaft 180 may extend from a turbine stage of the turbine engine 190 through a gearbox 250 and/or terminate at a central hub of the fan 140, such that the shaft 180 does not extend beyond the fan 140 to reach an in-line motor component. The stator 130 and/or associated control systems can be positioned at the rim of the fan 140 rather than along the shaft 180, which can allow the shaft 180 to have a reduced length relative to configurations in which an electric motor is positioned in-line between the turbine engine 190 and the fan 140. The reduced shaft length can decrease weight, can reduce complexity of bearing assemblies required to support the shaft 180, and/or can reduce deformation caused by vibration during operation. The shaft 180 may include a slight extension beyond a central coupling point to mount the fan 140. In some implementations, the shaft 180 can include a central core. The central core can provide structural support and/or alignment for the shaft 180 and/or coupled components, such as the rotor blades 170, the compressor 192, the combustor 194, and/or other components of the turbine engine 190. In some implementations, the shaft 180 can include load bearings. For example, the shaft 180 can include load bearings that couple the rotor blades 170 to the central core of the shaft 180 at the central hub of the fan 140. The load bearings can transfer a load from the rotor blades 170 to the shaft 180, such that mechanical stress is distributed from the rotor blades 170 through the load bearings and/or into the central core of the shaft 180. The load bearings can establish a load path that traverses from the tips of the rotor blades 170, where the rotor magnets 160 interact with the stator magnets 132, through the central hub and/or into the central core of the shaft 180, such that the rotor blades 170 are less or not cantilevered and/or structural stress is managed more effectively than in configurations in which the rotor blades 170 are mechanically supported only at a single radial location.

The system 100 can include the turbine engine 190. The turbine engine 190 can be a turbine-based engine coupled to the shaft 180 to provide thrust for an airborne platform. The turbine engine 190 can include the compressor 192 and the combustor 194. In some implementations, the turbine engine 190 can include a turbine stage that extracts energy from high-temperature, high-pressure gases produced by the combustor 194 to drive the shaft 180. The shaft 180 can mechanically couple the turbine stage to the compressor 192 and to the fan 140, such that rotational force generated by the turbine stage is transmitted through the shaft 180 to drive both the compressor 192 and the fan 140. The turbine engine 190 can operate in parallel with the drive system 110, such that both the turbine engine 190 and/or the drive system 110 contribute torque to the shaft 180 and/or to the fan 140 depending on the operational requirements of the system 100.

The compressor 192 can include an impeller, a diffusor, a manifold, and/or other components for compressing incoming air. The impeller can gather and/or accelerate incoming air radially outward toward the diffusor. For example, the impeller may include a rotating assembly with blades that impart kinetic energy to the air drawn into the compressor 192, such that the air velocity increases as it moves from an inlet region to an outer periphery of the impeller. The diffusor can receive the high-velocity air from the impeller and/or slow the air to convert kinetic energy into increased static pressure. For example, the diffusor may include stationary vanes or passages that expand in cross-sectional area in a downstream direction, such that the air velocity decreases and/or the pressure increases as the air passes through the diffusor. The manifold can collect the pressurized air from the diffusor and/or direct the pressurized air toward the combustor 194. In some implementations, the compressor 192 can include multiple stages, where each stage includes an impeller and a diffusor, such that the air undergoes multiple compression steps before entering the combustor 194. The combustor 194 can include a casing, a liner, a fuel injection system, an ignition system, a cooling system, a regeneration system, and/or other components for mixing fuel with compressed air and/origniting the mixture to produce high-temperature, high-pressure gases. For example, the fuel injection system may inject fuel into the combustor 194 at a location where the fuel mixes with the compressed air from the compressor 192. The ignition system may provide a spark or other ignition source to initiate combustion of the fuel-air mixture. The combustion process can heat the air at approximately constant pressure as the fuel-air mixture burns, such that the gases expand rapidly and/or increase in temperature. The combustor 194 can direct the high-temperature, high-pressure gases toward a turbine stage of the turbine engine 190, where the gases expand through turbine blades to extract energy and/or drive the shaft 180. In some implementations, the combustor 194 can include a cooling system that cools the hot combustion products to a temperature that turbine inlet guide vanes and/or turbine blades can withstand under operating conditions, such as by introducing additional air into the combustor 194 downstream of the combustion zone or by directing cooling air through passages in the turbine components. The gases exiting the turbine stage can be expelled through an exhaust system to provide thrust for the system 100.

The turbine engine 190 can be integrated (e.g., coupled) with the magnetic levitation-based motor component of the drive system 110 such that both the turbine engine 190 and the rotor 150 connect to the shaft 180. For example, the shaft 180 can transmit rotational force from the turbine stage of the turbine engine 190 and from the rotor blades 170 of the rotor 150 to the fan 140, such that the fan 140 can be driven by the turbine engine 190, by the drive system 110, or by both power sources operating in parallel depending on the operational requirements of the system 100. In some implementations, the fan 140 can be driven by combined power from the turbine engine 190 and the drive system 110 during high-demand phases such as takeoff, climb, or landing, such that both power sources contribute torque to the shaft 180 to increase the rotational speed of the fan 140 and/or generate additional thrust. For example, during a takeoff phase, the controller 120 may generate signals to energize the stator magnets 132 to output electromagnetic fields that interact with the rotor magnets 160 to produce torque at the blade tips of the rotor blades 170, and the turbine engine 190 may operate at a high power setting to produce rotational force via the shaft 180, such that the combined torque from both sources drives the fan 140 at a rotational speed sufficient to generate the thrust required for takeoff. In some implementations, during cruise operation, the turbine engine 190 may provide the majority of the power to drive the fan 140, and/or the drive system 110 may reduce or cease operation to conserve electrical energy, such that the system 100 operates primarily as a turbine-driven propulsion system during cruise.

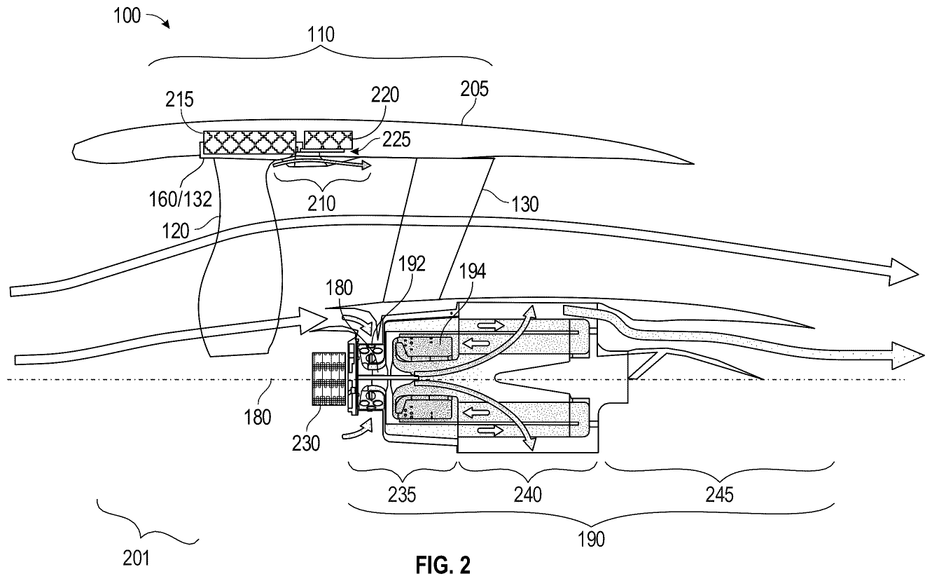

Referring now to FIG. 2, illustrated is a schematic diagram of an example embodiment of a magnetic levitation-based hybrid propulsion system 100. The system 100 can include a drive system 110, a fan 140, a shaft 180, a turbine engine 190, a gearbox 230, and/or various thermal management and/or control components. The drive system 110 can include a controller 120, a stator 130, a rotor 150, a motor bearing 215, at least one inverter controller 220, and a heat pipe 225. The stator 130 can include stator magnets 132. The rotor 150 can include rotor magnets 160 and rotor blades 170. The fan 140 can include a heat exchange diverter 210. The turbine engine 190 can include a compressor 192, a combustor 194, a gas turbine module 235, a heat exchanger module 240, and an exhaust mixer 245. The gearbox 250 can include a magnetic planetary gear 230. System 100 can include all of, some of, and/or additional components referenced in relation to FIG. 1, in addition to other components. For example, system 100 can include all of the components of drive system 110 and turbine engine 190. The system 100 may operate on vehicle 201.

The drive system 110 can include a rim 205 that forms an outer circumferential boundary of the fan 140 and/or provides structural integration for electromagnetic and mechanical components. The rim 205 can interact with the fan 140 by enclosing the tips of the rotor blades 170 and by supporting the stator 130 such that the stator magnets 132 are positioned adjacent to the rotor magnets 160 at the blade tips. In some implementations, the rim 205 can provide motor bearing support and/or magnetic control for tip-driven operation of the rotor blades 170. For example, the rim 205 may include mounting structures for one or more motor bearings 215 and/or for one or more inverter controllers 220, such that the motor bearings 215 constrain radial and/or axial motion of the rotor 150 relative to the stator 130 while the inverter controllers 220 receive electrical signals from the controller 120 and/or drive the stator magnets 132 to produce time-varying electromagnetic fields. The drive system 110 can include a heat exchange diverter 210 positioned at or near the rim 205 to facilitate thermal management of the motor bearings 215, the inverter controllers 220, and/or the stator magnets 132 during operation. The heat exchange diverter 210 can include at least one motor bearing 215, at least one inverter controller 220, and/or at least one heat pipe 225. The motor bearing 215 can be coupled with the rim 205 and/or can provide mechanical support for the rotor 150 to rotate relative to the stator 130 while maintaining the gap between the rotor magnets 160 and the stator magnets 132.

In some implementations, the motor bearing 215 can be a magnetic bearing that uses magnetic forces to suspend the rotor 150 without physical contact with the stator 130, such that friction and/or wear are reduced. For example, the motor bearing 215 may include electromagnets that generate magnetic fields to exert axial and/or radial forces on the rotor 150 to maintain a target gap distance between the rotor magnets 160 and the stator magnets 132. The inverter controller 220 may be integrated with or implemented as part of the controller 120, or may be a separate component communicatively coupled to the controller 120 to receive control signals therefrom. The inverter controller 220 can generate drive signals to energize the stator magnets 132 to produce electromagnetic fields that interact with the rotor magnets 160 to drive rotation of the rotor blades 170. In some implementations, the controller 120 can transmit control signals to the inverter controller 220 that specify current waveforms to be applied to coils of the stator magnets 132, such that the inverter controller 220 implements the control signals by driving the stator magnets 132 according to the specified waveforms. The inverter controller 220 can monitor operating temperatures of the stator magnets 132 and/or the motor bearing 215 by receiving temperature sensor data from sensors positioned at or near the rim 205, such that the inverter controller 220 can report the temperature sensor data to the controller 120 and/or the controller 120 can adjust the control signals to reduce power dissipation in the stator magnets 132 when the operating temperatures exceed a threshold temperature. For example, the controller 120 may reduce the magnitude of the control signals transmitted to the inverter controller 220 or may adjust the phase timing of the control signals to reduce resistive heating in the coils of the stator magnets 132. The heat pipe 225 can be coupled to the inverter controller 220 and/or to the motor bearing 215 to transfer heat generated by the stator magnets 132 and/or by the inverter controller 220 to a heat dissipation region. In some implementations, the heat pipe 225 can operate by phase-change heat transfer in which a working fluid within the heat pipe 225 evaporates at a hot end positioned near the inverter controller 220 and/or condenses at a cold end positioned at a heat exchanger or a cooling structure exposed to airflow, such that heat is transferred from the inverter controller 220 to the cooling structure without requiring active pumping. For example, the heat pipe 225 may extend radially inward from the rim 205 toward a central region of the fan 140 where airflow passes through the fan 140, and/or the cold end of the heat pipe 225 may be in thermal contact with a heat exchanger surface that is exposed to the airflow such that convective heat transfer removes heat from the heat pipe 225.

The system 100 can include a gearbox 230. The gearbox 230 can be positioned between the shaft 180 and/or at least one of the drive system 110 and/or the turbine engine 190 to transmit rotational force from the turbine engine 190 to the fan 140 and/or from the rotor 150 to the shaft 180. In some implementations, the gearbox 230 can be a magnetic gearbox that transmits torque between rotating components without physical contact between gear teeth. For example, the gearbox 230 may include a plurality of permanent magnets embedded in rotating structures such that magnetic forces between the magnets produce torque transmission rather than mechanical engagement of gear teeth, such that wear and/or friction losses associated with mechanical contact between gear teeth can be reduced. The gearbox 230 can be a magnetic planetary gearbox that includes a central sun gear, a plurality of planet gears positioned radially outward from the sun gear, and/or a ring gear positioned radially outward from the planet gears, where each of the sun gear, the planet gears, and/or the ring gear can include embedded permanent magnets arranged in patterns that produce magnetic coupling between adjacent gears. In some implementations, the planet gears can rotate about respective axes while orbiting the sun gear, such that the planet gears transmit torque from the sun gear to the ring gear or from the ring gear to the sun gear by magnetic interaction rather than by mechanical engagement. The gearbox 230 can connect the shaft 180 to the fan 140 such that rotational force from the turbine engine 190 is transmitted through the shaft 180 to the gearbox 230 and/or from the gearbox 230 to the fan 140. In some implementations, the gearbox 230 can receive torque contributions from both the turbine engine 190 via the shaft 180 and from the rotor blades 170 via electromagnetic interaction at the blade tips, such that the gearbox 230 sums or combines the torque contributions from both sources and transmits the combined torque to drive the fan 140. For example, the rotor blades 170 may be coupled to the ring gear of the gearbox 230 such that torque generated by electromagnetic interaction between the stator magnets 132 and the rotor magnets 160 at the blade tips is transmitted to the ring gear. The shaft 180 may be coupled to the sun gear such that torque from the turbine engine 190 is transmitted to the sun gear. The planet gears may transmit the combined torque from the ring gear and/or the sun gear to an output shaft or coupling that drives the fan 140. The gearbox 230 can alter the rotational speed ratio between the shaft 180 and the fan 140, such that the shaft 180 rotates at a first rotational speed and the fan 140 rotates at a second rotational speed different from the first rotational speed. In some implementations, the gearbox 230 can be a concentric magnetic gear that includes a high-speed rotor coupled to the shaft 180, a low-speed rotor coupled to the fan 140, and a stationary pole piece positioned between the high-speed rotor and the low-speed rotor, where the high-speed rotor and the low-speed rotor can include permanent magnets arranged in patterns that produce magnetic coupling through the pole piece to transmit torque from the shaft 180 to the fan 140 without mechanical contact. In some implementations, the gearbox 230 can be a mechanical planetary gearbox that includes a sun gear mechanically coupled to the shaft 180, a plurality of planet gears mechanically engaged with the sun gear, and/or a ring gear mechanically engaged with the planet gears and coupled to the fan 140, such that the gearbox 230 transmits torque from the shaft 180 to the fan 140 by mechanical engagement of gear teeth rather than by magnetic interaction. The shaft 180 can extend from the turbine engine 190 to a connection point proximate the gearbox 230, such that the shaft 180 terminates at or near the gearbox 230 rather than extending through the gearbox 230 to reach an in-line motor positioned beyond the fan 140.

The turbine engine 190 can include the gas turbine module 235. The gas turbine module 235 can be a section of the turbine engine 190 that encloses the compressor 192, the combustor 194, and/or a turbine stage that extracts energy from combustion gases to drive the shaft 180. In some implementations, the gas turbine module 235 can include a casing that provides structural support for the compressor 192, the combustor 194, and/or the turbine stage, such that the casing maintains alignment of rotating components and/or directs airflow through the compressor 192, the combustor 194, and/or the turbine stage in sequence. The compressor 192 can include one or more compressor wheels that gather and/or accelerate incoming air and/or increase the pressure of the air before the air enters the combustor 194. In some implementations, the compressor wheel can include an impeller that draws in air at an inlet region and/or accelerates the air radially outward toward a diffusor. For example, the impeller may include a rotating assembly with blades that impart kinetic energy to the air such that the air velocity increases as the air moves from the inlet region to an outer periphery of the impeller. The diffusor can receive the high-velocity air from the impeller and/or slow the air to convert kinetic energy into increased static pressure, such that the air pressure increases as the air passes through the diffusor. In some implementations, the diffusor may include stationary vanes and/or passages that expand in cross-sectional area in a downstream direction, such that the air velocity decreases and/or the air pressure increases as the air passes through the diffusor. The compressor 192 can direct the pressurized air toward the heat exchanger module 240. The heat exchanger module 240 can receive the pressurized air from the compressor 192 and/or transfer heat from exhaust gases exiting the turbine stage to the pressurized air before the pressurized air enters the combustor 194.

In some implementations, the heat exchanger module 240 can include a plurality of heat exchanger surfaces that separate the pressurized air from the exhaust gases such that thermal energy is transferred from the exhaust gases to the pressurized air by conduction through the heat exchanger surfaces, such that the temperature of the pressurized air increases and/or the temperature of the exhaust gases decreases. For example, the heat exchanger module 240 may include a regenerative heat exchanger that directs the exhaust gases from the turbine stage through flow passages positioned adjacent to flow passages through which the pressurized air from the compressor 192 passes, such that the pressurized air receives thermal energy from the exhaust gases before the pressurized air enters the combustor 194. The combustor 194 can receive the pressurized air from the heat exchanger module 240 and/or mix the pressurized air with fuel to produce a combustible mixture. In some implementations, the combustor 194 can include a casing, a perforated inner liner, a fuel injection system, and/or an ignition system. For example, the fuel injection system may inject fuel into the combustor 194 at a location where the fuel mixes with the pressurized air. The ignition system may provide a spark and/or other ignition source to initiate combustion of the fuel-air mixture. The combustor 194 can heat the pressurized air at approximately constant pressure as the fuel-air mixture burns, such that the gases expand rapidly and/or increase in temperature to produce high-temperature, high-pressure gases.

In some implementations, the combustor 194 can direct cooling air through passages in combustor walls and/or through passages in turbine components to cool the high-temperature gases to a temperature that turbine inlet guide vanes and/or turbine blades can withstand under operating conditions. The turbine engine 190 can include a turbine wheel positioned downstream of the combustor 194 to receive the high-temperature, high-pressure gases from the combustor 194. The turbine wheel can include a plurality of turbine blades attached to a rotating disk, such that the high-temperature, high-pressure gases expand through the turbine blades and/or exert forces on the turbine blades to cause the rotating disk to rotate. The rotating disk can be connected to the shaft 180, such that rotational force generated by the turbine wheel is transmitted through the shaft 180 to drive the compressor 192 and/or the fan 140. For example, the shaft 180 may extend from the rotating disk of the turbine wheel through the gas turbine module 235 and/or the gearbox 250 to the fan 140, such that the shaft 180 mechanically couples the turbine wheel to the compressor 192 and/or to the fan 140. The shaft 180 can drive the compressor 192 to compress incoming air and/or can drive the fan 140 to generate thrust, such that the fan 140 can be powered by the turbine engine 190 and/or by the drive system 110 operating in parallel in the hybrid propulsion system 100. The turbine engine 190 can include the exhaust mixer 245 positioned downstream of the turbine wheel to receive exhaust gases exiting the turbine wheel. The exhaust mixer 245 can combine the exhaust gases from the turbine wheel with bypass air that passes around the turbine engine 190 to produce a mixed exhaust flow that is expelled from the system 100 to generate thrust. In some implementations, the exhaust mixer 245 may include a mixing duct that directs the exhaust gases from the turbine wheel and the bypass air into a common flow path such that the exhaust gases and the bypass air mix to produce the mixed exhaust flow, and/or the mixed exhaust flow may be directed through an exhaust nozzle to accelerate the mixed exhaust flow and increase the thrust generated by the system 100.

The system 100 can include or be coupled with or provided for a propulsion platform (e.g., vehicle) that incorporates the magnetic levitation-based hybrid propulsion system for aerial operations. The propulsion platform can include a fuselage and/or the system 100 coupled to the fuselage to generate thrust for takeoff, landing, cruise, and/or other flight operations. The drive system 110 can be used to control operation of the propulsion platform by generating electromagnetic forces at the rim 205 of the fan 140 that interact with the rotor magnets 160 at the blade tips to drive the rotor blades 170. The controller 120 can provide signals to the stator magnets 132 to drive the rotor blades 170 such that the propulsion platform achieves desired movement corresponding to commands received from a user interface and/or an autopilot system. In some implementations, the propulsion platform can include a fuselage structure that houses electrical power sources such as batteries and/or fuel cells that supply electrical current to the inverter controller 220 for driving the stator magnets 132. For example, the fuselage may include battery modules positioned at locations where thermal runaway events can be contained and/or where exhaust gases from a thermal event can be vented overboard without affecting occupants and/or flight-critical systems.

The propulsion platform (e.g., vehicle 201) can include mounting structures that couple the system 100 to the fuselage such that thrust generated by the fan 140 and exhaust generated by the turbine engine 190 are transmitted to the fuselage to produce forward motion and/or vertical lift. In some implementations, the mounting structures may include struts and/or pylons that attach the system 100 to a wing structure and/or to a central body of the fuselage, such that aerodynamic loads and/or propulsive forces are distributed through the mounting structures into the airframe. The propulsion platform can include flight control surfaces such as ailerons, elevators, and/or rudders that receive control inputs from the controller 120 to adjust pitch, roll, and/or yaw angles of the propulsion platform in coordination with thrust changes produced by the system 100. The shaft 180 can extend from the turbine engine 190 to the fan 140 and/or need not extend to an in-line motor because motor components are located at the fan rim 205, such that the shaft 180 has a reduced length relative to configurations in which an electric motor is positioned between the turbine engine 190 and the fan 140 along the shaft 180.

The system 100 can be provided for and/or coupled with a vehicle 201 to provide propulsion for aerial operations. The vehicle 201 can be an aircraft, a vertical takeoff and landing platform, a tilt-rotor aircraft, a tilt-wing aircraft, a fixed-wing aircraft, a rotorcraft, an unmanned aerial vehicle, or any other airborne platform that requires propulsion for flight. The vehicle 201 can include a fuselage that houses occupants, cargo, avionics systems, electrical power sources such as batteries or fuel cells, and/or control systems, etc. The system 100 can be mounted to the fuselage via structural attachments such as struts, pylons, or mounting brackets that transfer thrust forces and/or aerodynamic loads from the system 100 to the airframe of the vehicle 201. The drive system 110 can receive electrical power from the batteries or fuel cells housed in the fuselage, and/or the controller 120 can receive commands from a pilot via a user interface located in the fuselage or from an autopilot system integrated with the avionics systems. The turbine engine 190 can receive fuel from fuel tanks housed in the fuselage or in the wings of the vehicle 201, and/or can generate thrust, for example, by expelling exhaust gases through an exhaust outlet that directs the exhaust gases rearward relative to the vehicle 201. The fan 140 can be positioned at a forward location on the vehicle 201 to draw ambient air into the system 100 and/or accelerate the air through the rotor blades 170 to generate thrust that propels the vehicle 201 forward or produces vertical lift depending on the orientation of the system 100 relative to the fuselage. The controller 120 can coordinate operation of the drive system 110 and the turbine engine 190 to control pitch, roll, yaw, altitude, and/or speed of the vehicle 201 by adjusting the thrust produced by the fan 140 and by the exhaust gases expelled by the turbine engine 190. For example, during a takeoff phase, the controller 120 can generate signals to operate the drive system 110 and/or the turbine engine 190 at high power levels to produce sufficient thrust to lift the vehicle 201 from the ground. For example, during a cruise phase, the controller 120 can generate signals to operate primarily the turbine engine 190 to maintain forward speed while reducing power delivered by the drive system 110 to conserve electrical energy stored in the batteries or fuel cells.

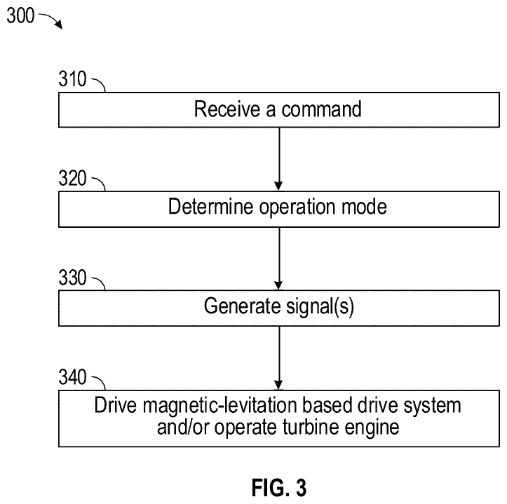

Referring now to FIG. 3, illustrated is a flow diagram of a method 300 for controlling operation of a hybrid propulsion system. The method 300 can be executed, performed, or otherwise carried out by any of the systems, apparatuses, vehicles and/or devices described herein (e.g., system 100). In brief overview of the method 300, the method 300 can include receiving a command to execute a maneuver, determining at least one operation mode based on the command, generating signals based on the at least one operation mode, and/or operating a magnetic levitation-based drive system and/or a turbine-based engine based on the signals.

The method 300 can include receiving a command to execute a maneuver. The command can be received by a controller of the propulsion platform. The controller can receive the command from a user interface via user input. For example, the user interface may present a touchscreen display with selectable control elements corresponding to takeoff, landing, or cruise operations, and/or a pilot may select one of the control elements to transmit the command to the controller. In some implementations, the controller can receive the command from an autopilot. For example, the autopilot may generate the command to initiate movement toward a waypoint of a flight plan, such that the command indicates a desired change in altitude, heading, or speed required to navigate toward the waypoint. The command can be received at the beginning of a flight phase. For example, the command may be received when a pilot initiates a takeoff procedure by selecting a takeoff control element on the user interface, or when the pilot initiates a landing procedure by selecting a landing control element. The controller can receive the command via a communication interface that couples the controller to the user interface or to the autopilot system. For example, the communication interface may be a wired connection such as a data bus, or a wireless connection such as a radio frequency link, such that the command is transmitted electronically to the controller. The command may be encoded as a data packet that includes parameters such as a desired altitude change, a desired speed change, or a desired heading change. The controller can parse the data packet to extract the maneuver information from the parameters.

The method 300 can include determining at least one operation mode based on the command. The at least one operation mode can be determined by the controller of the propulsion platform. The controller can use flight dynamics models and/or control laws to determine the at least one operation mode. For example, the flight dynamics models may include equations that relate airspeed, altitude, and/or thrust requirements to expected lift and/or propulsion values. The controller can evaluate the equations using input parameters extracted from the command to calculate the expected values. The controller can determine an amount of power or percentage of power to be provided by the drive system and the turbine engine. For example, the controller may calculate that during a takeoff operation mode, the drive system is to provide 40% of the total power and the turbine engine is to provide 60% of the total power, and/or during a cruise operation mode, the drive system is to provide 10% of the total power and the turbine engine is to provide 90% of the total power. The controller can determine the at least one operation mode in response to receiving the command. For example, if the command indicates a takeoff maneuver, the controller may determine that the operation mode is a takeoff mode. If the command indicates a landing maneuver, the controller may determine that the operation mode is a landing mode. The controller can determine the at least one operation mode by executing the flight dynamics models stored in memory to calculate expected lift and propulsion values, comparing the expected values to threshold values associated with different operation modes, and/or selecting the operation mode that corresponds to the command. For example, the controller may compare a calculated expected lift value to a takeoff threshold value stored in memory. If the expected lift value exceeds the takeoff threshold value, the controller may select the takeoff mode. In some implementations, the controller can determine upcoming changes in operation modes. For example, the controller may determine that a landing procedure will begin shortly based on proximity to a destination waypoint, such that the controller can adjust the operation mode in advance to prepare the drive system and/or the turbine engine for the landing phase.

The method 300 can include generating signals based on the at least one operation mode. The signals can be generated by the controller of the propulsion platform. The controller can generate signals to control at least one of the drive system or the turbine engine. For example, during a takeoff operation mode or a landing operation mode, the controller may generate signals that energize both the stator magnets of the drive system and the combustor of the turbine engine. During a cruise operation mode, the controller may generate signals that operate only the turbine engine and reduce or cease energization of the stator magnets. The controller can generate the signals after determining the at least one operation mode, such that the signals are tailored to the specific power and/or thrust requirements of the determined operation mode. In some implementations, the signals may gradually increase power in a pre-takeoff mode. For example, the controller may generate signals that incrementally increase the current supplied to the stator magnets over a period of several seconds prior to initiating full takeoff thrust, such that the rotor blades accelerate gradually to a target rotational speed. The controller can generate the signals by retrieving signal parameters from memory, calculating signal waveforms based on the operation mode, and/or transmitting the signals to the drive system and/or the turbine engine via communication interfaces. For example, the controller may retrieve a set of amplitude values, frequency values, and/or phase values from memory for the determined operation mode, and/or may calculate time-varying voltage waveforms by evaluating sinusoidal functions with the retrieved amplitude, frequency, and/or phase values as inputs. The signals may include time-varying voltage waveforms that specify amplitude, frequency, and/or phase parameters to be applied to the stator magnets. For example, the signals may include a first voltage waveform with a first amplitude and/or a first frequency to be applied to a first subset of the stator magnets, and/or a second voltage waveform with a second amplitude and/or a second frequency to be applied to a second subset of the stator magnets, such that the first and/or second voltage waveforms produce a rotating electromagnetic field pattern around the circumference of the stator. The signals may include fuel flow rates and/or combustor control parameters to be applied to the turbine engine. For example, the signals may include a fuel flow rate value specifying a mass flow rate of fuel to be injected into the combustor per unit time, and/or a combustor control parameter specifying an ignition timing value for initiating combustion of the fuel-air mixture in the combustor.

The method 300 can include operating a magnetic levitation-based drive system and/or a turbine-based engine based on the signals. The drive system and/or the turbine engine can be operated by actuating components in response to the signals generated by the controller. Operating the drive system can include driving, based on the signals, a plurality of stator magnets of a stator to output one or more magnetic fields to interact with one or more rotor magnets of a rotor to drive a plurality of rotor blades to act as a fan. The stator magnets can be driven in response to receiving the signals from the controller, such that the stator magnets output electromagnetic fields immediately upon receiving the signals. For example, upon receiving a signal indicating a takeoff mode, the stator magnets may be energized by applying the time-varying voltage waveforms specified in the signal to coils of the stator magnets, such that the coils generate electromagnetic fields that interact with the rotor magnets at the tips of the rotor blades, causing the rotor blades to rotate rapidly and/or generate high thrust. The stator can drive the stator magnets based on the signals by applying specific waveforms to the stator magnets to output electromagnetic fields that cause desired rotor and/or fan movement. For example, the stator may apply a three-phase sinusoidal waveform to three subsets of the stator magnets positioned at 120-degree intervals around the circumference of the stator, such that the electromagnetic fields produced by the three subsets combine to form a rotating field pattern that exerts a tangential force on the rotor magnets and/or drives the rotor to rotate continuously. In some implementations, the turbine engine can receive signals that adjust fuel injection rates into the combustor, control ignition timing, and/or regulate airflow through the compressor stages. For example, the turbine engine may receive a signal specifying a fuel injection rate of 0.5 kilograms per second and/or an ignition timing value of 10 milliseconds before top dead center, and/or the turbine engine may adjust a fuel injector to inject fuel at the specified rate and/or adjust an ignition system to initiate combustion at the specified timing, such that the turbine engine operates at a power level consistent with the determined operation mode.

The method 300 can include operating the drive system and/or the turbine engine based on the signals such that the turbine engine alone drives the fan during the cruise mode while the drive system reduces or ceases to provide power to the fan. For example, in the cruise mode, the controller may generate signals that specify a fuel injection rate for the combustor to maintain a thrust level sufficient for cruise operation, and/or may generate signals that reduce the current supplied to the stator magnets to a reduced level or to zero such that the electromagnetic fields produced by the stator magnets exert reduced torque or no torque on the rotor magnets. Reducing power delivered by the drive system can include decreasing the amplitude of voltage waveforms applied to the stator magnets such that the electromagnetic fields produced by the stator magnets exert reduced torque on the rotor magnets. In some implementations, reducing power delivered by the drive system can include ceasing to supply current to the stator magnets such that the stator magnets produce no electromagnetic fields and/or exert no torque on the rotor magnets.

In some implementations, the controller can determine an upcoming transition from a first operation mode to a second operation mode and/or can adjust the signals prior to the transition to change a relative contribution of the turbine engine and/or the drive system to driving the fan. For example, the controller may determine that a landing procedure will begin shortly based on proximity to a destination waypoint, such that the controller generates signals that gradually increase the current supplied to the stator magnets over a period of time prior to the landing phase, and/or the controller may generate signals that gradually increase the fuel injection rate to the combustor such that both the drive system and/or the turbine engine provide increasing torque to the fan as the landing phase approaches. The controller can adjust the signals to operate the drive system and/or the turbine engine in a pre-takeoff mode in which power to the stator magnets and/or to the combustor is increased incrementally over a period of time to accelerate the fan to a target rotational speed for takeoff. For example, the controller may generate signals that incrementally increase the amplitude of the voltage waveforms applied to the stator magnets from a first amplitude value to a second amplitude value over a period of ten seconds, and/or may generate signals that incrementally increase the fuel injection rate from a first fuel flow rate to a second fuel flow rate over the same period, such that the fan accelerates smoothly to the target rotational speed without abrupt changes in thrust.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The construction and arrangement of the systems and methods as shown in the various exemplary implementations are illustrative only. Although only example implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, such modifications are intended to be included within the scope of the present disclosure. The order or sequence of any process or method steps can be varied or re-sequenced according to alternative implementations. Other substitutions, modifications, changes, and omissions can be made in the design, operating conditions and arrangement of the exemplary implementations without departing from the scope of the present disclosure.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is

1. A system for magnetic levitation-based hybrid propulsion, comprising:
an engine coupled to a shaft, the engine comprising a compressor and a combustor;
a fan comprising a plurality of rotor blades coupled to the shaft;
a drive system comprising a rotor coupled with the plurality of rotor blades and a stator to provide power to the rotor.

2. The system of claim 1, wherein the rotor is at least partially spaced from the stator by a gap.

3. The system of claim 1, wherein the drive system comprises a plurality of rotor magnets and a plurality of stator magnets, the plurality of stator magnets configured to output one or more magnetic fields to interact with one or more of the plurality of rotor magnets to drive the rotor.

4. The system of claim 3, wherein at least one of the plurality of rotor magnets are positioned at a tip of a corresponding rotor blade, and the plurality of stator magnets are configured to output the one or more magnetic fields to drive the at least one of the plurality of rotor magnets at the tips of the corresponding rotor blade to rotate the fan.

5. The system of claim 3, wherein the plurality of stator magnets is arranged in at least one of:
an axial flux configuration in which the plurality of stator magnets is positioned on opposite axial sides of the plurality of rotor magnets; or
a radial flux configuration in which the plurality of stator magnets is positioned radially outward from tips of the plurality of rotor blades.

6. The system of claim 1, wherein the drive system is configured to drive the rotor blades to provide airflow to the engine via the fan, and wherein the engine further provides power to the fan and thrust, and wherein the stator and associated control circuitry are integrated into a rim of the fan.

7. The system of claim 1, wherein the shaft extends from the engine to the fan to couple the engine with the fan, and wherein the plurality of rotor blades is coupled to a central hub of the fan such that a load path traverses from tips of the plurality of rotor blades through the central hub into a central core of the shaft.

8. The system of claim 1, wherein the fan comprises a shrouded fan having the plurality of rotor blades enclosed by a casing, wherein the plurality of rotor blades comprise a plurality of rotor magnets, and wherein the stator and the plurality of rotor magnets are arranged at the casing to form a tip-driven motor integrated with a rim of the shrouded fan.

9. The system of claim 1, further comprising a controller configured to:
receive a command indicating a maneuver of a propulsion platform;
determine an operation mode based on the command; and
generate one or more drive signals based on the operation mode to operate at least one of the drive system and the engine.

10. The system of claim 9, wherein the operation mode comprises at least one of a takeoff mode, a climb mode, a cruise mode, and a landing mode, and wherein the controller is configured to:
in the takeoff mode or the landing mode, operate the engine and the drive system in parallel to drive the fan; and
in the cruise mode, operate the engine to drive the fan while reducing power delivered by the drive system.

11. A method for operating a magnetic levitation-based hybrid propulsion system, the method comprising:
receiving, by a controller, a command indicating a maneuver of a platform;
determining, by the controller, at least one operation mode based on the command;
generating, by the controller, one or more signals based on the at least one operation mode; and
operating at least one of a magnetic levitation-based drive system and a turbine-based engine based on the one or more signals, wherein operating the magnetic levitation-based drive system comprises driving, based on the one or more signals, a plurality of stator magnets of a stator to output one or more magnetic fields that interact with one or more rotor magnets of a rotor to drive a plurality of rotor blades acting as a fan.

12. The method of claim 11, further comprising:
in response to determining that the at least one operation mode corresponds to at least one of a takeoff mode and a landing mode, generating the one or more signals to operate the turbine-based engine and the magnetic levitation-based drive system in parallel to drive the plurality of rotor blades.

13. The method of claim 11, further comprising:
in response to determining that the at least one operation mode corresponds to a cruise mode, generating the one or more signals to operate the turbine-based engine to drive the plurality of rotor blades while reducing power delivered by the magnetic levitation-based drive system.

14. The method of claim 11, further comprising:
determining, by the controller, an upcoming transition between a first operation mode and a second operation mode; and
adjusting the one or more signals prior to the transition to change a relative contribution of the turbine-based engine and the magnetic levitation-based drive system to driving the plurality of rotor blades.

15. The method of claim 11, wherein driving the plurality of stator magnets comprises applying time-varying electrical currents to coils of the stator to generate the one or more magnetic fields, and wherein the one or more magnetic fields cause the rotor to rotate while being at least partially spaced from the stator by a gap.

16. The method of claim 11, further comprising:
generating, by rotation of the plurality of rotor blades, airflow toward a compressor of the turbine-based engine; and
generating, by the turbine-based engine, thrust based on combustion of fuel with compressed air from the compressor.

17. The method of claim 11, further comprising:
transmitting torque from tips of the plurality of rotor blades through a central hub of a fan and into a shaft coupled to the turbine-based engine, the torque being generated at least in part by interaction between the plurality of stator magnets and the one or more rotor magnets.

18. The method of claim 11, further comprising:
causing, based on operating of the magnetic levitation-based drive system and the turbine-based engine, a change in at least one of lift, thrust, pitch, roll, or yaw of a vehicle comprising the hybrid propulsion system.

19. A vehicle, comprising:
a fuselage; and
a propulsion system coupled to the fuselage, the propulsion system comprising:
an engine coupled to a shaft, the engine comprising a compressor and a combustor;
a fan comprising a plurality of rotor blades coupled to the shaft; and
a drive system comprising a rotor coupled with the plurality of rotor blades and a stator configured to provide power to the rotor.

20. The vehicle of claim 19, wherein the drive system comprises a plurality of rotor magnets and a plurality of stator magnets, at least one rotor magnet positioned at a tip of a corresponding rotor blade, and the plurality of stator magnets configured to output one or more magnetic fields that interact with the at least one rotor magnet at the tip of the corresponding rotor blade to drive the fan.
